(19) United States
(12) Patent Application Publication
(10) Pub. No.: US 2014/0349159 A1
(43) Pub. Date: Nov. 27, 2014

(54) ELECTROCHEMICAL CELLS AND RELATED DEVICES

(71) Applicant: General Electric Company, Schenectady, NY (US)

(72) Inventors: Brandon Alan Bartling, Bethlehem, NY (US); Michael Alan Vallance, Loudonville, NY (US); Richard Louis Hart, Broadalbin, NY (US)

(21) Appl. No.: 13/898,876

(22) Filed: May 21, 2013

(51) Int. Cl. H01M 10/39

(52) U.S. Cl. CPC H01M 10/39
USPC 429/103

(57) ABSTRACT

An electrochemical cell is presented. The electrochemical cell includes an ion-conducting separator having a first surface that defines at least a portion of a first compartment and a second surface that defines at least a portion of a second compartment, and a positive electrode composition disposed in the first compartment, the positive electrode composition comprising an electroactive metal, an alkali metal halide, and an electrolyte. The electroactive metal includes metal flakes of an average aspect ratio greater than about 5. An energy storage battery including a plurality of electrochemical cells is also presented.

### BACKGROUND OF THE INVENTION

This invention relates generally to electrochemical cells. In some specific embodiments, the invention relates to high-temperature, rechargeable electrochemical cells, and related devices.

Recently, with the rapid development of hybrid vehicles, consumer electronic devices, related equipment and communication equipment, there is a demand for a battery or other type of electrochemical cell that can go through a relatively rapid charge cycle after every discharge, with minimized deterioration in the operation of the cell, i.e., with minimized increase in internal resistance; minimized decrease in discharge capacity; and minimized time required for charging the cell after every discharge cycle. There is large need for development of electrochemical cells, having high energy density, increased power output, and stable response over thousands of cycles.

Metal halide electrochemical cells (for example, sodium-metal chloride batteries) including a molten metal negative electrode (usually referred to as the anode) and a beta-alumina solid electrolyte, are of considerable interest. In addition to the anode, the cells include a positive electrode (usually referred to as the cathode) that supplies/receives electrons during the charge/discharge of the cells. The cathode composition typically includes a porous interspersed mixture of electroactive metal and alkali metal halide powders, impregnated with molten electrolyte. The metal network is the electrode in one aspect, and it performs as a three-dimensional electronic conduction grid for the cathode in another aspect.

To minimize an activation over-potential and thereby increase charging and discharging power, a high-surface area electroactive metal is preferred. This is typically accomplished by using the metal powder with small dimensions. For example, nickel powder produced by gas-phase reduction of carbonyl nickel is a preferred form of the metal powder. The resulting nickel powder is a highly-branched, high surface area nickel powder, which may also be referred to as “dendritic nickel.” However, a metal network formed of the metal powders of such fine dimensions are susceptible to severe local cyclic corrosion, to the extent that the electronic conduction network is rendered inoperative locally, which generally leads to increased cell resistance, decreased charging and discharging power, and reduced capacity. Accordingly, high power and long cycle-life appear to be in conflict with each other, and there has been a demand for cathode designs capable of attaining them simultaneously.

Additionally, when employing a high-surface area metal powder of the type described above, for example dendritic nickel powders prepared from carbonyl nickel, the packing density of the cathode composition is reduced relative to a cathode composition prepared with a coarse metal powder (e.g., mechanically milled nickel). Low packing density corresponds to low cell capacity, whereas most applications demand high cell capacity. In an attempt to overcome the shortcomings of the above-mentioned approach, a combination of low-surface area powder and high-surface area dendritic powder has also been employed (as described in U.S. Publication No. 20110104563).

However, these batteries (such as sodium metal halide cells) may, under some conditions, degrade very rapidly, and have short cycle life. It may therefore be desirable to have an electrochemical cell that exhibits improvements in these properties, as compared to the cells that are currently available.

### BRIEF DESCRIPTION OF THE INVENTION

One embodiment of the invention is directed to an electrochemical cell. The electrochemical cell includes:

(a) an ion-conducting separator having a first surface that defines at least a portion of a first compartment and a second surface that defines at least a portion of a second compartment; and

(b) a positive electrode composition disposed in the first compartment, the positive electrode composition comprising an electroactive metal, an alkali metal halide, and an electrolyte; wherein the electroactive metal comprises metal flakes of an average aspect ratio greater than about 5.

Another embodiment of the invention is directed to a positive electrode composition including an electroactive metal, an alkali metal halide, and an electrolyte. The electroactive metal includes metal flakes of an average aspect ratio greater than about 5

In one embodiment, an energy storage device comprising an electrochemical cell is provided. The electrochemical cell includes:

(a) an ion-conducting separator having a first surface that defines at least a portion of a first compartment; and a second surface that defines at least a portion of a second compartment; and

(b) a positive electrode composition disposed in the first compartment, the positive electrode composition comprising an electroactive metal, an alkali metal halide, and an electrolyte; wherein the electroactive metal comprises metal flakes of an average aspect ratio greater than about 5.

### DRAWINGS

FIG. 1 is a schematic, cross-sectional view of a portion of an electrochemical cell, in accordance with some embodiments of the invention.

FIG. 2 is a schematic, cross-sectional view of a portion of an electrochemical cell, in accordance with other embodiments of the invention

FIG. 3 is a schematic representation of metal flakes, in accordance with some embodiments of the invention.

FIG. 4 is a plot of energy-per-day as a function of charging and discharging cycles for electrochemical cells, using conventional and modified electro active metals.

FIG. 5 is a plot of charging current as a function of amp-hr charged, for electrochemical cells using conventional and modified electro-active metals.

### DETAILED DESCRIPTION

This invention relates generally to electrochemical cells. In some specific embodiments, the invention relates to a high-temperature, rechargeable electrochemical cell, and related devices.

Approximating language, as used herein throughout the specification and claims, may be applied to modify any quantitative representation that could permissibly vary, without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

As used herein, the term “anode material” refers to a material that accepts electrons during charging, and is present as part of a redox reaction. The term “cathode material” refers to a material that supplies electrons during charging and is also present as part of the redox reaction. The cathode material is present as a participating electrochemical reactant, either in its oxidized or reduced state, or at some state between full oxidation and reduction. In some cases, the cathode material may include a single metal. In other cases, the cathode material may comprise multiple metals. An electrolyte, as used herein, is a medium that provides the ion transport mechanism between the positive and negative electrodes of a cell.

As used herein, the term “high temperature” generally refers to temperatures above about 220 degrees Celsius (° C.), unless otherwise indicated.

In some embodiments, an electrochemical cell is presented. The electrochemical cell includes (a) an ion-conducting separator having a first surface that defines at least a portion of a first compartment and a second surface that defines at least a portion of a second compartment; and (b) a positive electrode composition disposed in the first compartment, the positive electrode composition comprising an electroactive metal, an alkali metal halide, and an electrolyte; wherein the electroactive metal comprises metal flakes.

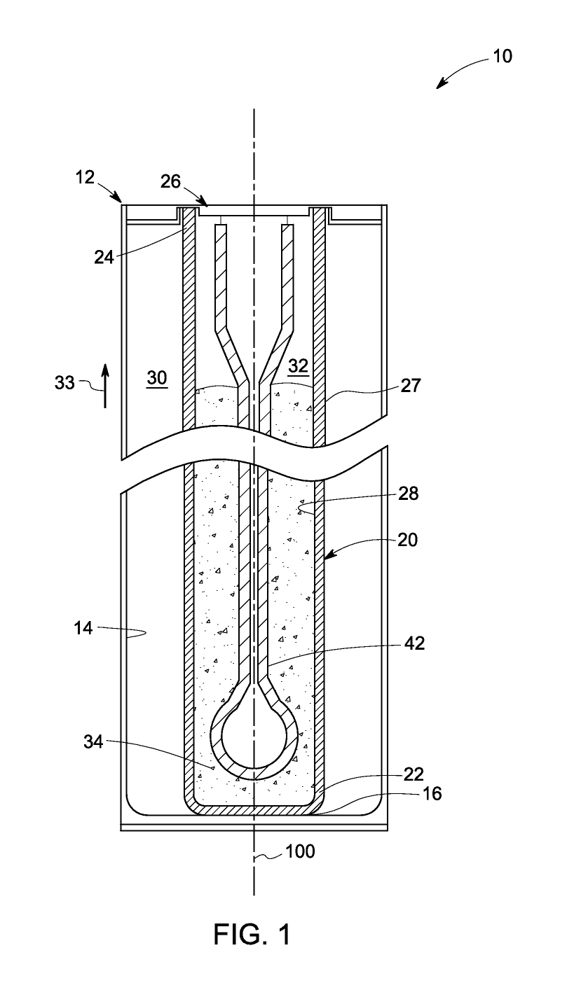

FIG. 1 illustrates a schematic of an electrochemical cell 10, according to one embodiment of the invention. The electrochemical cell 10 includes a housing 12 having an interior surface 14 that defines a volume. The housing 12 may also be referred to as “casing.” The housing 12 may define an axial direction 100 substantially perpendicular to a base 16 of the housing. In one embodiment, the housing 12 may have a cross sectional profile that is circular, elliptical, or polygonal, for example. With regard to the material, the housing 12 may be formed from a metal, ceramic, a composite, or combinations thereof. Suitable materials may include nickel, iron, or molybdenum. Specific examples may be mild steel, stainless steel, nickel-coated steel, and molybdenum-coated steel.

The electrochemical cell 10 includes a separator 20 disposed in the volume of the housing 12. In the illustrated embodiment, the separator 20 may be cylindrical, elongate, tubular, or cup-shaped, with a closed-end 22 and an open-end 24, for a cylindrical or tubular cell. In one embodiment, the separator may be substantially planar; and the corresponding cell may be a planar electrochemical cell. Referring to FIG. 1 again, the open-end 24 of the separator 20 may be sealable, and a sealing means (not shown) may be a part of a separator assembly that defines an aperture 26 for filling the separator tube 20 with a cathode material during the manufacturing process.

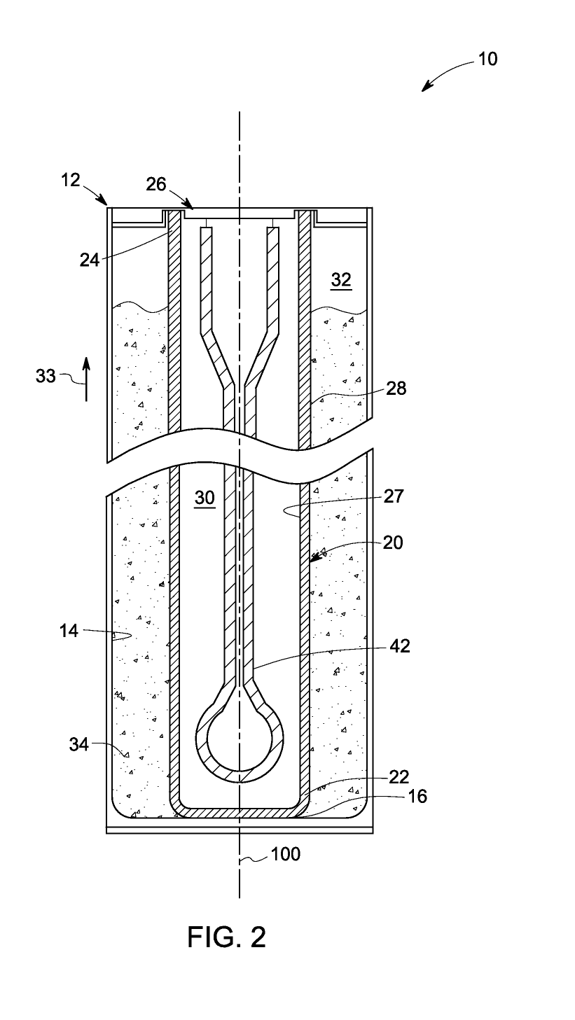

In some embodiments, the separator 20 may be sized and shaped to have a cross-sectional profile configured to provide a maximum surface area for an alkali metal ion transport. In some embodiments, the separator may have a cross-sectional profile normal to the axial direction 100 of the housing 12 (FIGS. 1 and 2). The separator may have a cross-sectional profile that may be a circle, an oval or ellipse, a triangle, a square, a rectangle, a polygon, a cross-shape, a star shape, or a cloverleaf shape, for example. In some particular embodiments, the separator may have a cross-sectional profile in a cloverleaf shape. This cloverleaf shape may increase the overall, available surface area of the separator, for a given volume, while maintaining reasonable burst strength for situations where a cathode compartment and an anode compartment are maintained at dissimilar pressures.

In some embodiments, the separator 20 is a solid separator. In some embodiments, the solid separator includes an ion-conductor solid electrolyte capable of conducting alkali metal ions. Suitable materials for the solid separator may include an alkali-metal-beta-alumina, alkali-metal-beta″-alumina, alkali-metal-beta′-gallate, or alkali-metal-beta″-gallate. In some embodiments, the solid separator may include a beta-alumina, a beta″-alumina, a gamma alumina, or a micromolecular sieve such as, for example, a tectosilicate, such as a feldspar, or a feldspathoid. Other exemplary separator materials include zeolites, for example a synthetic zeolite such as zeolites 3A, 4A, 13X, and ZSM-5; rare-earth silicophosphates; silicon nitride; beta′-alumina; beta″-alumina; gamma alumina; a micromolecular sieve; or a silicophosphate (NASICON: Na₃Zr₂Si₂PO₁₂). In some embodiments, the separator may include a soda-containing borosilicate glass. In some specific embodiments, the separator 20 includes a beta″-alumina separator electrolyte (BASE).

In some embodiments, the separator may be stabilized by the addition of small amounts of a dopant. The dopant may include one or more oxides selected from lithia, magnesia, zinc oxide, and yttria. These stabilizers may be used alone or in combination with themselves, or with other materials.

As mentioned above, the separator often includes a beta alumina material. In one embodiment, a portion of the separator is alpha alumina, and another portion of the separator is beta alumina. In some embodiments, the alpha alumina (a non-ionic-conductor) may help with sealing and/or fabrication of the cell.

In some embodiments, at least one of the alkali metals in the positive electrode composition may be sodium, and the separator may be beta-alumina. In another embodiment, the alkali metal may be potassium or lithium, with the separator then being selected to be compatible therewith. For example, in embodiments where the ions include potassium, silver, strontium, and barium cations, the separator material may include beta alumina. In certain other embodiments, where lithium cations are used, lithiated borophosphate BPO₄—Li₂O, may be employed as the separator material.

The separator 20 may be characterized by a selected ionic conductivity. The resistance of the separator 20 (i.e., across its thickness) may depend in part on the thickness of the separator wall itself. A suitable thickness can be less than about 5 millimeters, and the thickness can be varied from one location to another location. A cation facilitator material may be disposed on at least one surface of the separator, in one embodiment. The cation facilitator material may include, for example, selenium, as discussed in published U.S. Patent Application No. 2010/0086834, incorporated herein by reference.

With continued reference to FIG. 1, the separator 20 has a first surface 28 that defines a portion of a first compartment 32 (e.g., a cathode compartment or a positive electrode compartment). The housing 12 is generally a container that defines a second compartment 30 (e.g., an anode compartment or a negative electrode compartment) between an interior surface 14 of the housing 12, and a second surface 27 of the separator 20. The cathode compartment 32 is disposed within the anode compartment 30, in these instances. In some other embodiments, the second compartment 30 is disposed within the first compartment 32, as indicated in FIG. 2. In such instances, the anode compartment 30 is disposed within the cathode compartment 32. The terms “first compartment” and the “cathode compartment” are used herein interchangeably. Further, the terms “second compartment” and the “anode compartment” are used herein interchangeably. The first compartment 32 is in ionic communication with the second compartment 30 through the separator 20. As used herein, the phrase “ionic communication” refers to the traversal of alkali metal ions between the first compartment 32 and the second compartment 30, through the separator 20. The anode compartment 30 and the cathode compartment 32 further include current collectors to collect the current produced by the electrochemical cell. Optionally, the casing may serve as a current collector.

As noted earlier, a positive electrode composition (or cathode material) 34 is disposed inside the first compartment (cathode compartment) 32. In some embodiments, the positive electrode composition 34 includes at least one electroactive metal, at least one alkali metal halide, and at least one electrolyte.

In some embodiments, the electroactive metal is selected from the group consisting of titanium, vanadium, niobium, molybdenum, nickel, cobalt, chromium, manganese, silver, antimony, cadmium, tin, lead, iron, zinc, and combinations thereof. In some specific embodiments, the electroactive metal includes nickel, iron, zinc, cobalt, chromium, or combinations thereof. In particular embodiments that are preferred for some end uses, the electroactive metal is nickel. In some embodiments, the positive electrode composition includes at least two electroactive metals. In some embodiments, the at least two electroactive metals include nickel and iron.

In some embodiments, the electroactive metal is substantially free of copper. The term “substantially free” as used herein means that the amount of copper in the positive electrode composition is less than about 1 weight percent. Without being bound by any theory, it is believed, that copper, if present in the positive electrode composition, may sometimes oxidize to form one or both of cuprous (+1) and cupric (+2) ions. These ions are soluble in the electrolyte, and may therefore be transported to the separator, leading to swelling and fracture of the separator. In some particular embodiments, the amount of copper in the positive electrode composition is less than about 0.01 weight percent.

As discussed above, the electroactive metal has typically been used in powder form in the positive electrode of the cell. For example, most of the current sodium metal halide cells use nickel powder (e.g., Ni 255 nickel powder marketed by Vale), formed through the decomposition of carbonyl nickel. The resulting cells exhibit good performance in initial operational cycles. However, the cells sometimes begin to degrade as they are cycled continuously.

Embodiments of the invention as described herein provide an electroactive metal that comprises high aspect ratio metal flakes. The metal flakes, in general, refer to a continuous, relatively thin particle that may also be relatively flat or undulating, also sometimes termed as a “platelet”, having an average thickness much lower than other dimensions. The aspect ratio is a helpful measurement in this context, referring to the ratio of the largest dimension (other than thickness) to the thickness dimension. As used herein, “high aspect ratio flakes” can be defined as continuous thin particles having a thickness in a range of from about 0.5 micron to about 3 microns, and having an average ratio of a largest dimension (other than thickness) to a thickness dimension greater than about 5. In some embodiments, the metal flakes have an aspect ratio in a range of from about 5 to about 40. In some embodiments, the metal flakes have an aspect ratio in a range of from about 8 to about 30, and in some embodiments, from about 10 to about 20. In some embodiments, the average thickness of the metal flakes is in a range of from about 1 micron to about 2 microns.

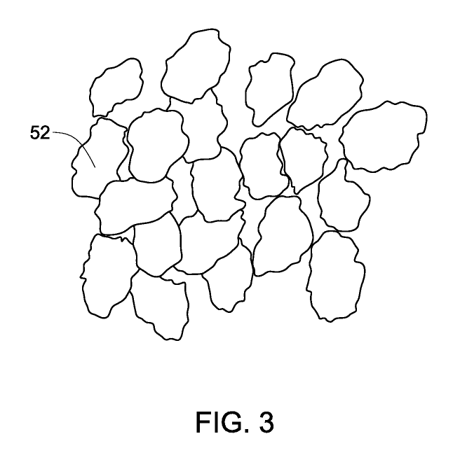

FIG. 3 illustrates a schematic of one type of flakes or flat particles of the electroactive metal. These flakes or flat particles 52 are often irregular in shape. As mentioned above, each of these flakes or thin particles may have an undulating surface. These flakes can be achieved by milling a metal powder. In some embodiments, the metal powder includes metal particles or irregular pieces of milled metal particles. In other embodiments, the metal powder includes particles produced by atomization.

In one embodiment, milling of the metal powder is carried out by a high energy milling technique. Milling is usually carried out for a selected period of time with a rotational speed that depends, in part, on the size (or surface area) of the particles and/or pieces of the electroactive metal fed into a milling chamber, along with the desired size and shape of the metal flakes after milling. Non-limiting examples of high-energy milling may include planetary milling, attrition milling, ball milling, airjet milling, pulveriser techniques, or a combination thereof. In some specific embodiments, the metal powder may be ball-milled to achieve the desired flake characteristics. Other techniques may be used for milling the metal powder to form the metal flakes. Thus, it is to be understood that any method of attaining the metal flakes that have the desired characteristics should fall within the scope of this invention.

In one embodiment, the milling is performed in air. In other embodiments, the milling chamber is tightly sealed, and the milling of the metal powder can be performed in a vacuum or in a protective atmosphere.

The positive electrode composition can contain a large amount of the metal flakes, e.g., up to about 100 percent. In some embodiments, the metal flakes are present in the positive electrode composition in an amount of at least about 40 weight percent of the total amount of the electroactive metal. In some embodiments, the amount of the metal flakes may range from about 50 weight percent to about 80 weight percent, based on the total weight of the electroactive metal. The electroactive metal may additionally be present in other forms, such as filaments, fibers, granules, particles, foam or the like.

In some embodiments, the bulk density of the electroactive metal in the positive electrode composition may range from about 0.5 grams/cm³ to about 3 grams/cm³. In some embodiments, a ratio of a packing density to the bulk density of the electroactive metal may range from about 0.05 to about 0.4.

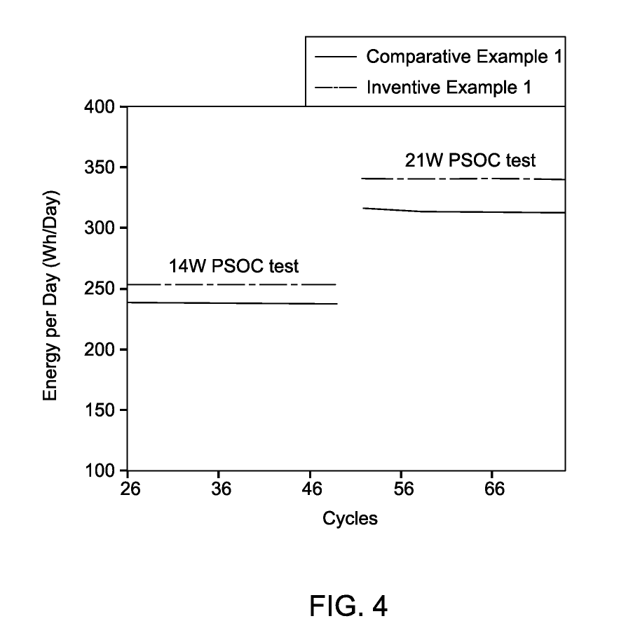

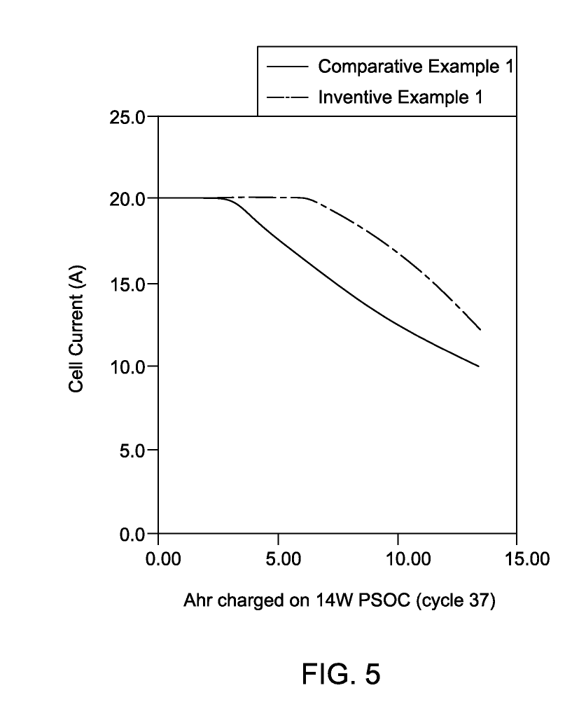

Use of such metal flakes in the positive electrode composition, as described above (for example, nickel flakes), can provide many improvements, including sustained charge current (i.e. high charge acceptance), and a high amount of energy delivered per day during continuous cycling, as compared to dendritic nickel based cells (FIGS. 4 and 5). These improvements may be attributed to the robust conductive network formed with the metal flakes. Metal flakes with high aspect ratios may have a high number of contact points with the neighboring flakes, thereby establishing a strong network. This contrasts with the fragile structure of a high surface area metal powder (for example, dendritic nickel), which may degrade rapidly as cycled continuously. Thus, replacing the dendritic nickel with the nickel flakes may provide greater resistance to network breakdown, which can increase the electrical charging capabilities of the cell.

As noted previously, the positive electrode composition further includes at least one alkali metal halide. In some embodiments, a suitable alkali metal halide includes at least one halide of sodium, potassium, or lithium. In some embodiments, the halide can be a chloride, bromide, or fluoride. In some embodiments, the positive electrode composition includes at least one sodium halide, e.g., sodium chloride. In some embodiments, the positive electrode composition includes at least two alkali metal halides. One such example includes sodium chloride and at least one of sodium iodide and sodium fluoride. In some embodiments, sodium iodide, sodium bromide or sodium fluoride, when present, is at a level (individually) of about 0.1 weight percent to about 0.9 weight percent, based on the weight of the entire positive electrode composition. Some specific positive electrode compositions are described in copending application Ser. No. 13/034184 (Bogdan Jr. et al); filed on 24 Feb. 2011, and incorporated herein by reference. In some embodiments, the electroactive metal and the alkali metal halide powders may be intimately combined, and rendered in the form of granules, for inclusion in the cathode compartment 32 in FIG. 1 and FIG. 2.

In some embodiments, the electroactive metal is present in the positive electrode composition at a concentration greater than a stoichiometric amount, relative to the alkali metal halide. For example a molar ratio of the electroactive metal to the alkali metal halide in the positive electrode composition is sometimes greater than about 1. In particular embodiments, a molar ratio of the electroactive metal to the alkali metal halide in the positive electrode composition is in a range from about 2 to about 5. As noted, in some embodiments, the positive electrode composition may include a plurality of electroactive metals and/or a plurality of alkali metal halides. In such embodiments, the molar ratio of the electroactive metal to the alkali metal halide may be calculated using the cumulative molar content of the electroactive metals and/or the cumulative molar content of the alkali metal halides.

In some embodiments, a concentration of the electroactive metal in the positive electrode composition is greater than about 35 weight percent of the positive electrode composition (excluding electrolyte). In some embodiments, a concentration of the electroactive metal in the positive electrode composition is greater than about 45 weight percent of the positive electrode composition. In some embodiments, a concentration of the electroactive metal in the positive electrode composition is in a range about 50 weight percent to about 60 weight percent of the positive electrode composition.

Without being bound by any theory, it is believed that at least a portion of the excess electroactive metal (relative to the alkali metal halide) in the positive electrode composition may provide for current collection in the axial direction, in addition to the current collection in the radial direction.

Referring again to FIGS. 1 and 2, in some embodiments, the composition of the positive electrode composition is substantially constant in the axial direction 100. The term “substantially constant” as used herein means that an amount of the electroactive metal in the positive electrode composition varies by less than about 5 percent in the axial direction. In some embodiments, the composition of the positive electrode composition is substantially constant in the axial direction during the discharged state, the charged state, or both the charged and discharged states of the electrochemical cell.

In another embodiment, the positive electrode composition is compositionally graded in the axial direction 100. The term “compositionally graded” as used herein means that an amount of the electroactive metal in the positive electrode composition varies in the axial direction. In a particular embodiment, the amount of the electroactive metal in the positive electrode composition may decrease radially in a direction away from the center of the first compartment 32, and towards the base of the first compartment 32. In some embodiments, the composition of the positive electrode composition is compositionally graded in the axial direction during the discharged state, the charged state, or both the charged and discharged states of the electrochemical cell.

Furthermore, in embodiments including a compositionally graded positive electrode composition, the concentration of the electroactive metal may increase along the general direction 33. A lower electroactive metal concentration proximate to the base of the first compartment 32, and a relatively higher electroactive metal concentration proximate to the open end 24 of the separator 20, may provide for current flow and collection in the axial direction.

In some embodiments, the cathode compartment 32 further includes an electrolyte. The positive electrode composition can be infused with a molten electrolyte. In some embodiments, the molten electrolyte transports the ions from a separator to the positive electrode, and vice-versa. In one embodiment, the molten electrolyte includes a binary salt including an alkali metal halide and an aluminum halide. In a specific embodiment, the molten electrolyte comprises sodium tetrachloroaluminate (NaAlCl₄). In some embodiments, the molten electrolyte may include one or more additional metal halides, and forms a ternary or quaternary electrolyte.

In addition to the components discussed above, the positive electrode composition may include a number of other constituents, in some embodiments. As an example, aluminum may be included in the positive electrode composition in a form other than its form in the electrolyte salt, and other than as an aluminum halide. In some embodiments, the aluminum may be in elemental form, e.g., aluminum metal flakes or particles. In some embodiments, the amount of elemental aluminum present in the positive electrode composition may be in a range from about 0.2 weight percent to about 2 weight percent, based on the weight of the positive electrode composition, not including the electrolyte. In some embodiments, the positive electrode composition may also include carbon.

In some embodiments, the positive electrode composition may further include sulfur, in the form of molecular sulfur or a sulfur-containing compound, such as a metal sulfide. Suitable examples of metals in the metal sulfide include alkali metals or transition metals. In one embodiment, the positive electrode composition includes a metal polysulfide. In one embodiment, the metal polysulfide includes iron disulfide, sodium disulfide, nickel disulfide, cobalt disulfide, manganese disulfide, or combinations thereof. If present, the level of sulfur may be in a range from about 0.1 weight percent to about 25 weight percent, based on the total weight of the positive electrode composition. However, as described in application Ser. No. 13/034,184, in some embodiments, the positive electrode composition may be substantially free of sulfur, i.e., containing, at most, impurity levels.

In some embodiments, the positive electrode composition may also include other additives that beneficially affect the performance of an electrochemical cell. Such performance additives may increase ionic conductivity, increase or decrease solubility of the charged positive electrode species, improve wetting of a solid electrolyte, i.e., the separator, by the molten electrolyte; or prevent ripening of the positive electrode micro-domains. In some embodiments, the performance additive may be present in an amount that is less than about 1 weight percent, based on the total weight of the positive electrode composition. Examples of such additives include one or two additional metal halides, e.g., sodium fluoride or sodium bromide.

In one embodiment, the positive electrode composition is disposed on an electronically conductive support structure. The support structure may not undergo any chemical reaction during the charge/discharge, and may simply support the cathode material during chemical reactions. The support structure may be in a number of forms, such as a foam, a mesh, a weave, a felt, or a plurality of packed particles, fibers, or whiskers. In one embodiment, a suitable support structure may be formed from carbon or a metal.

With continued reference to FIG. 1, the electrochemical cell 10 further includes a positive current collector 42. The positive current collector 42 is in electrical communication with the positive electrode composition 34 in the cathode compartment 32. The term “electrical communication” as used herein means that the positive current collector 42 is capable of conducting electrical current from the cathode compartment 32 to the cell's external positive terminal.

In some embodiments, the positive current collector 42 may have a shape selected from the group consisting of a hollow tube, a wire, a brush, a plate, and combinations thereof. Suitable materials for the positive current collector include platinum, palladium, gold, nickel, copper, carbon, titanium, and combinations thereof. The positive current collector may be plated or clad in some embodiments. In some other embodiments, the positive current collector includes a solid metal current collector. In one embodiment, the current collector is substantially free of iron. In one embodiment, the current collector is substantially free of copper. In a particular embodiment, the positive current collector includes nickel.

As described earlier, the electrochemical cell 10 (FIGS. 1-2) includes the anode compartment 30 comprising an anode material (not shown). Typically, the anode compartment 30 is empty in the ground state (uncharged state) of the electrochemical cell. The anode compartment 30 is then filled with metal from reduced metal ions that move from the cathode compartment 32 to the anode compartment 30 through the separator 20, during operation of the cell. The anode compartment 30 may receive and store a reservoir of the anode material, in some embodiments. Typically, the anode material includes an alkali metal. Non-limiting examples of the anode material may include lithium, sodium, or potassium. The anode material is usually molten during use. In one embodiment, the anode material includes sodium, and may in fact be comprised primarily of sodium.

In some embodiments, the anode material may include one or more additives. Additives suitable for use in the anode material may include a metallic oxygen scavenger. Suitable metal oxygen scavengers may include one or more of manganese, vanadium, zirconium, aluminum, or titanium. Other useful additives may include materials that increase wetting of the separator surface defining the anode compartment, by the molten anode material. Additionally, some additives or coatings may enhance the contact or wetting between the separator and the current collector, to ensure substantially uniform current flow throughout the separator. Some additives in the anode compartment may act as thermal energy conductors between the outside surface of the separator and the inside surface of the housing. Some additives may serve as sacrificial anodes, in an event that the separator ruptures, preventing or delaying corrosion of the housing.

The electrochemical cell 10 may also include a negative electrode current collector (not shown) disposed in the anode compartment 30. The negative electrode current collector may also be referred to as an anode current collector. The anode current collector is in electrical communication with the anode compartment. Suitable materials for the anode current collector include iron, steel, aluminum, tungsten, titanium, nickel, copper, molybdenum, carbon, and combinations thereof.

In one embodiment, a shim structure may also function as a current collector, as described herein. In some embodiments, one or more shim structures may be disposed within the volume of the housing i.e. in the anode compartment 30, in intimate contact with the second surface 27 of the separator. In some embodiments, the shim structures may support the separator within the volume of the housing. The shim structures may protect the separator from vibrations caused by the motion of the cell during use, and thus reduce or eliminate movement of the separator relative to the housing.

Some embodiments are directed to a positive electrode composition comprising an electroactive metal, an alkali metal halide, and an electrolyte; wherein the electroactive metal comprises metal flakes. As described previously, the use of the metal flakes in the electroactive metal component can provide distinct performance advantages, when the positive electrode is incorporated into various types of electrochemical devices.

In some embodiments, a plurality of the electrochemical cells (each of which may be considered a rechargeable electrochemical cell), as described herein, may be organized into an energy storage battery. Multiple cells may be connected in series or parallel, or in a combination of series and parallel. A group of coupled cells may be referred to as a module or pack. The ratings for the power and voltage of the module may depend on such factors as the number of cells, and the connection topology in the module. Other ratings, such as cycle life and power, may be based on end-use application specific criteria.

In some embodiments, the electrochemical cells illustrated herein may be rechargeable over a plurality of charge-discharge cycles. In one embodiment, the electrochemical cell may be employed in an uninterruptable power supply (UPS) device, wherein one or a plurality of such cells are maintained at a prescribed state of charge. At such time that a primary power source becomes unavailable, the UPS device supplies make-up power, supplied by discharging the cell or cells, until such time that the primary power source is re-established.

The embodiments of the invention provide improved charge acceptance and longer cycle life of a sodium metal halide cell.

### EXAMPLES

The examples presented below are intended to be merely illustrative, and should not be construed to be any sort of limitation on the scope of the claimed invention. Unless specified otherwise, all of the components are commercially available from common chemical suppliers.

### Example 1

### Making of Cells

Two sodium chloride/nickel based electrochemical cells were assembled, using the corresponding compositions provided in Table 1. Comparative Example 1 represents the cell that includes dendritic Ni, and Inventive Example 1 represents the cell that includes nickel flakes in the positive electrode composition.

Two electrochemical cells similar to that of FIG. 1 were assembled; and reference to the figure (cell 10) will be made here, to aid in this description. The cylindrical separator tube 20 for the cell 10, closed at the bottom and cloverleaf in profile, was formed according to known methods. Each tube 20 was formed from ceramic sodium-conductive beta″-alumina (β″-alumina tube) powder slurries. The cylinder dimensions were 228 millimeters length (210 mm of useful length), 39.1 millimeters, internal span, and 41.8 millimeters, outside span. These were dimensions from lobe tip to lobe tip. The open end of each ceramic separator tube was glass sealed to a coaxial alpha alumina collar assembly (not shown), to form a seal assembly. The collar assembly included the alpha alumina collar and two nickel rings bonded to an inner surface and an outer surface of the collar, respectively. The inner and outer nickel rings were then welded to the metallic cathode current collector 42 and to the top of the steel cell housing 12, respectively. The current collector 42 for the cathode is a U-shaped rod which runs nearly the full length of the separator tube to within about 5 mm of the closed end. The cell housing 12 serves as the anode current collector. The cell housing, square in cross section, was about 36 millimeters×36 millimeters×240 millimeters×0.4 millimeters thick.

These cells were assembled in the discharged state. The anode compartments contained no sodium at the time of assembly. The compacted positive electrode compositions (or cathode compositions) according to Table 1, except the electrolyte, were poured into the respective separator tubes, through the fill ports at the seal assemblies, and the granule bed of the cathode composition was densified by vibration on a vibratory shaker in an argon filled glove box.

TABLE 1
Composition details of electrochemical cells.

| Cathode | | | | | | | | Elec- |
|---|---|---|---|---|---|---|---|---|
| Composition | | | | | | | | tro- |
| Wt % | NaCl | Ni | Fe | Al | NaF | NaI | FeS | lyte |
| Comparative | 23.9 | (Ni | 3.38 | 0.32 | 0.91 | 0.25 | 0.99 | 30.16 |
| Example 1 | | powder) | | | | | | |
| | | 40.0 | | | | | | |
| Inventive | 23.9 | (Ni | 3.38 | 0.32 | 0.91 | 0.25 | 0.99 | 30.16 |
| Example 1 | | flakes) | | | | | | |
| | | 40.0 | | | | | | |

### Comparative Example 1 Electrochemical Cell Employing Dendritic Nickel Powder in a Positive Electrode

The sodium chloride (NaCl) was obtained from a commercial source, already milled and vacuum-dried, and having an average particle size of less than about 95 micrometers. The material was re-dried in an oven at 240° C., before use. Positive electrode materials, all in powder form, including dendritic nickel powder (Ni255), sodium chloride, sodium fluoride, sodium iodide, iron, and aluminum powder, were roll mixed and pressed at ambient room temperature (typically about 18° C.-25° C.), under a linear pressure of about 16-25 kN/cm, using an Alexanderwerk WP50N/75 Roll Compactor/Milling Machine. The resulting agglomerate ribbon was granulated with a classifier mill; and the fraction containing a particle size distribution of about 0.325 to about 1.5 millimeters was used for the cell assembly.

The electrolyte, sodium tetrachloroaluminate (NaAlCl₄), was obtained from Sigma Aldrich as granules. The electrolyte was melted in an evacuated heated funnel attached to the fill port in the seal assembly. The molten sodium tetrachloroaluminate NaAlCl₄ electrolyte flowed into the cathode granule bed in the β″-alumina tube, while the cell was held at 280° C., using a close-fitting, tube furnace. The vacuum was released, the funnel was removed, and a nickel cap was welded across the fill port in the seal assembly using a commercial tungsten inert gas welding system, in order to seal the cathode from the environment. The cell was subsequently cooled to room temperature for handling. The above steps, including granule filling, electrolyte filling and sealing, were done in an argon-purged glove box. The resulting electrochemical cell was then subjected to charging/discharging cycling with the case temperature controlled at 300° C. as described below.

### Inventive Example 1

### Electrochemical Cell Employing Ni Flakes in the Positive Electrode

An electrochemical cell was fabricated using the method described above in Comparative Example 1, except the positive electrode composition includes nickel flakes. Nickel flakes were obtained through a commercial ball-milling process. In this process, nickel ingots of a size substantially larger (about 1 mm to about 5 mm diameter) than the desired size of the flakes were placed in the milling equipment containing milling lubricant. The nickel ingots were then milled until the desired size and shape is achieved. The resulting nickel flakes were removed from the milling equipment through standard separation steps that included mechanical and thermal treatments. The resulting flakes were irregular in shape, having an average thickness about 1.5 microns and an average diameter about 15 microns.

### Example 2

### Testing of Cells

The testing of cells was carried out using a 100 Å, 10V, multi-channel Bitrode battery testing system. The testing protocol involved a series of alternate charging, at about 20 Å or about 2.67V, and discharging, at about 14 W, with each charge and discharge over 13.5 Ahrs. After a set of twenty five charging and discharging cycles. a capacity check to about 2.1V was performed to understand capacity loss when discharging at 14 W. Then, a similar set of alternate charging, at about 20 Å or about 2.67V, and discharging, at about 21 W, was performed with each charge and discharge cycle over 13.5 Ahrs. After twenty five charge and discharge cycles with this protocol, a capacity check to about 2.1V was performed to understand capacity loss when discharging at 21 W.

FIG. 4 is a graph representing energy per day as a function of total charging and discharging cycles for 14 W and 21 W partial state of charge (PSOC), for 40 Ah. Energy/day is defined as 38 W-h divided by total discharge+charge time in days. An improvement in the energy delivered per day is observed for both the PSOC tests. Differences between the two cells (comparative example 1 and Inventive example 1) are also greater for the higher power condition of 21 W. This may be due to higher charge acceptance at higher rates for the Inventive example 1 cell.

Higher charge acceptance is further illustrated in FIG. 5, which is a graph comparing the charging current as a function of amp-hr charged. In this testing protocol, charging of a cell has a 20 Å single cell current limit. Initially, the comparative example 1 cell and the Inventive example 1 cell in both conditions were able to support maximum current. As the cells continued to charge, the level of current that can be supported by the comparative example 1 cell begins to decay around the 5-Ahr mark; while the Inventive example 1 cell continued to sustain this current longer. The difference in the charging current result in an overall greater amount of energy delivered per day, for a cell containing nickel flakes, as compared to dendritic nickel.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electrochemical cell, comprising:
(a) an ion-conducting separator having a first surface that defines at least a portion of a first compartment; and a second surface that defines at least a portion of a second compartment; and
(b) a positive electrode composition disposed in the first compartment, the positive electrode composition comprising an electroactive metal, an alkali metal halide, and an electrolyte; wherein the electroactive metal comprises metal flakes of an average aspect ratio greater than about 5.

2. The electrochemical cell of claim 1, wherein a molar ratio of the electroactive metal to the alkali metal halide in the positive electrode composition is greater than about 1.

3. The electrochemical cell of claim 1, wherein a molar ratio of the electroactive metal to the alkali metal halide in the positive electrode composition is in a range from about 2 to about 5.

4. The electrochemical cell of claim 1, wherein a concentration of the electroactive metal in the positive electrode composition is greater than about 35 weight percent of the positive electrode composition.

5. The electrochemical cell of claim 1, wherein the electroactive metal comprises at least about 40 weight percent metal flakes, based on the total amount of the electroactive metal.

6. The electrochemical cell of claim 1, wherein the electroactive metal comprises from about 50 weight percent to about 80 weight percent metal flakes, based on the total amount of the electroactive metal.

7. The electrochemical cell of claim 1, wherein the metal flakes are irregular in shape.

8. The electrochemical cell of claim 1, wherein sustantially each of the metal flakes has an undulating surface.

9. The electrochemical cell of claim 1, wherein the metal flakes have an average thickness in a range from about 0.5 micron to about 3 microns.

10. The electrochemical cell of claim 1, wherein the metal flakes have an average aspect ratio in a range from about 5 to about 40.

11. The electrochemical cell of claim 10, wherein the metal flakes have an average aspect ratio in a range from about 8 to about 30.

12. The electrochemical cell of claim 1, wherein the electroactive metal has a bulk density in a range from about 0.5 grams/cm³ to about 3 grams/cm³.

13. The electrochemical cell of claim 1, wherein the electroactive metal has a ratio of a packing density to a bulk density in a range from about 0.05 to about 0.4.

14. The electrochemical cell of claim 1, wherein the electroactive metal comprises one or more metals selected from titanium, vanadium, niobium, molybdenum, nickel, cobalt, chromium, manganese, silver, antimony, cadmium, tin, lead, iron, zinc, and combinations thereof.

15. The electrochemical cell of claim 1, wherein the first compartment defines an axial direction substantially perpendicular to a base of the first compartment, and the positive electrode composition is compositionally graded in the axial direction.

16. The electrochemical cell of claim 15, wherein an amount of the electroactive metal in the positive electrode composition decreases in a direction toward the base of the first compartment.

17. The electrochemical cell of claim 1, wherein the alkali metal halide comprises at least one halide of sodium, potassium, or lithium.

18. The electrochemical cell of claim 1, wherein the second compartment comprises sodium, potassium, or lithium.

19. An energy storage battery comprising a plurality of electrochemical cells in accordance with claim 1.

20. A positive electrode composition, comprising an electroactive metal, an alkali metal halide, and an electrolyte; wherein the electroactive metal comprises metal flakes of an average aspect ratio greater than about 5.
